(19) United States
(12) Patent Application Publication
(10) Pub. No.: US 2011/0153164 A1
(43) Pub. Date: Jun. 23, 2011

(54) Method and control unit for activating at least one safety device

(76) Inventors: Marcus Hiemer, Kehlen (DE); Mike Schwarz, Frankenberg (DE)

(21) Appl. No.: 12/937,774

(22) PCT Filed: Feb. 16, 2009
(86) PCT No.: PCT/EP2009/051748

§ 371 Date: Jan. 26, 2011

(30) Foreign Application Priority Data
Apr. 16, 2008 (DE) 10 2008 001 215.7

(51) Int. Cl. B60R 21/013

(52) U.S. Cl. 701/45

(57) ABSTRACT

A method for activating at least one safety device that has a first step of acquiring at least two features from at least one signal of a crash sensor system in order to form a feature vector from the features acquired. In a second method step, the formed feature vector is subsequently classified with the aid of a classifier based on the statistical learning theory in order to classify the feature vector in one of at least three possible feature classes. As a third method step, the safety devices are activated in accordance with an activation instruction for the feature class in which the feature vector was classified.

### FIELD OF THE INVENTION

The present invention relates to a method for activating at least one safety device, a control unit for activating at least one safety device, a computer program, and a computer-program product.

### BACKGROUND INFORMATION

Existing triggering algorithms for personal-protection devices such as airbags do not evaluate a movement history of a vehicle, or do so only too imprecisely to permit optimal triggering of safety devices. In existing systems, a triggering decision is made generally on the basis of the acceleration signals which occur in the case of a crash and are measured by acceleration sensors. Predictive systems such as “precrash” attempt, for example, to precondition the triggering algorithms by way of RADAR or LASER sensors. However, in conventional methods, these signals are not, or are only insufficiently combined with the information from the remaining sensors installed in the vehicle, so that a combined evaluation of the data of all sensor signals already available in principle is not carried out at present for reasons of the complexity of such an evaluation.

To improve the safety of the passengers of a vehicle, in the future, the evaluation of the active and passive safety components, which up to now still operate separately from each other, will be merged. In the course of this merger, the number of demands on a safety system will increase markedly, since the number of driving situations to be taken into account will rise exponentially. This rising number of driving situations to be considered should be countered by the combination and evaluation, to the greatest extent possible, of all signals available in the vehicle. In contrast to conventional triggering systems, it would be advantageous to take the history of the movement of the vehicle considered into account, and to efficiently use or combine information from the available sensors. However, at present, this requires a very complicated circuit structure to evaluate the signals available.

German Patent Application No. 10 2006 038151 A1 describes a device and a method for controlling personal-protection devices, in which the personal-protection devices are triggered using a support vector machine. In that case, a signal from a crash sensor is evaluated using different classification trees, in which a binary classification is implemented. Compared to the technology of “neural networks,” the use of the support vector machine has the advantage that, for each classification problem, an optimal solution is able to be found which, moreover, may be ascertained relatively easily, as well.

In German Patent Application No. DE 102007 027649, a method and a control unit for activating personal-protection devices are described in which, in order to activate personal-protection devices, a decision algorithm for evaluating features of a crash-sensor signal, as well as a support vector machine are used, which prepare a multidimensional classification of further additional features for the decision algorithm. In that case, a classification of the additional features into two different classes is used.

In both of these applications, however, a further optimization of the decision to trigger safety devices by way of the trigger circuit is possible, in order to efficiently combine and evaluate a plurality of signals from a crash sensor system (or variables derived from them). In this manner, the sensor signals from a history of the vehicle movement already available in vehicles may be evaluated even better for the purpose of activating the safety devices.

### SUMMARY

An object of the present invention is to provide a possibility for improving the evaluation of the sensor signals available.

According to example embodiments of the present invention, a method for activating at least one safety device is provided. One example method includes the following steps:
Acquisition of at least two features from at least one signal of a crash sensor system, in order to form a feature vector from the features acquired;
Classification of the formed feature vector with the aid of a classifier based on the statistical learning theory in order to classify the feature vector in one of at least three possible feature classes; and
Activation of the safety device in accordance with an activation instruction for the feature class in which the feature vector was classified.

According to example embodiments of the present invention, signal features of a crash-sensor signal are classified into more than two classes by a classifier based on the statistical learning theory which permits a marked improvement of the interconnection possibilities and the rapid evaluation of such signal features. This optimization is based generally on the fact that, due to the different classes, immediately upon classification in more than two classes, a good preparation or separation of the signal features may be implemented, which simplifies signal processing in an activation unit downstream in the signal path. Since, on one hand, the classifiers based on the statistical learning theory work numerically efficiently and rapidly, and on the other hand, are able to process a great number of signal features, a large quantity of crash-sensor-system signals already available in the vehicle may also be evaluated in optimum fashion by the use of such classifiers. The desired merger of the active and passive safety systems with their corresponding sensors is thereby accelerated.

In particular, given the use of more than two feature classes, a crash classification of a collision of vehicles may be implemented better and, above all, more accurately than conventionally. A more precise reaction of the vehicle safety system to the collision of two vehicles or already prior to such a collision of two vehicles thus becomes realizable. By an exact switching-in of the safety devices necessary for a specific crash type recognized, it thereby becomes possible to initiate exactly the suitable countermeasure against such a crash scenario.

According to one advantageous specific embodiment of the present invention, classifying with the aid of the classifier based on the statistical learning theory includes the use of a multiclass support vector machine. The use of such a multiclass support vector machine provides an excellent choice for a classifier based on the statistical learning theory that is rapid, efficient numerically or in terms of circuit engineering and, above all, precisely functioning.

In a further specific embodiment of the present invention, the activation of the safety device in accordance with an activation instruction for a first feature class may include the activation of a personal-protection device. Moreover, the activation of the safety device in accordance with an activation instruction for a second feature class may also include the activation of a vehicle-dynamics support control. It is thereby ensured to advantage that the features extracted from a single crash signal are used for different safety functions in a vehicle, so that a merger of the active and passive safety components in the vehicle is simplified by the approach proposed here. At the same time, particularly by the use of the multiclass support vector machine, a rapid and precise classification is achieved which permits a reduction in expenditure in terms of computation or circuit engineering for the operation of the suitable trigger unit of the individual safety device in the vehicle.

It is also beneficial if furthermore, the safety device is activated using at least one feature of the feature vector or a further feature from a signal of the crash sensor system. The one feature from the feature vector itself or the feature of the signal from the crash sensor system may thereby be used in a physical kernel algorithm, which forms a fallback option in the activation of the corresponding safety device. In this manner, a triggering operation is carried out reliably even in the event the indicated classifier malfunctions, as well as which, in particular, the triggering of the corresponding safety device may then be improved and/or sharpened in precision by way of the classifier described above. This means an exclusive increase in safety when implementing this specific embodiment of the present invention.

Furthermore, upon classification, it is advantageously possible to ascertain a classification functional value, and to activate the safety device using the classification functional value. This represents a further refinement of the classification result, since not only a class as such, but also a differentiation of the triggering within a class is now possible. Such a differentiation on the basis of the classification functional value then permits an even more precise control of the corresponding safety device, e.g., by a stepped activation of different airbag stages.

According to another specific embodiment of the present invention, the safety device may be activated in accordance with an activation instruction that is based on a decision threshold value. An activation instruction is thereby implemented which is very simple and easily realizable numerically or from the standpoint of circuit engineering, so that only low-complexity components may be used to realize the present invention according to this specific embodiment.

Furthermore, in the activation step, the activation instruction may also be modified according to a modification instruction as a function of the feature class. Such a modification of the activation instruction as a function of the specific feature class makes it possible to induce the activation of the safety device in a simple and, above all, very rapid manner. In this way, by interconnection and simple modification of the safety device or their components usually already present in a vehicle, a considerable plus in passenger safety may be attained in the operation of these safety devices.

Especially in the step of the activation as a function of the feature class, the decision threshold value may be increased or decreased, or the decision threshold value may be replaced by a second decision threshold value. Due to this easy-to-implement change in the activation instruction, the safety of the passengers of a vehicle may be improved to a great extent by classification of a feature vector in several (especially more than three) classes. In this context, likewise only slight changes in the structure of the corresponding safety device or its associated trigger circuit are necessary due to the alteration or exchange of the decision threshold value.

In another specific embodiment of the present invention, the classification may be carried out on the basis of class boundaries between the feature classes, which are loaded from a memory. In this case, a classifier is pre-trained, e.g., in the laboratory of the manufacturer, and is already optimally adjusted on the basis of crash scenarios or simulations, whereupon its trained parameters are then stored in a memory. As a result, a classifier is obtained which functions quickly and precisely in operation, since a complicated adaptation of the settings of the classifier is no longer necessary during operation.

In order to realize the advantages of the present invention, in a further specific embodiment of the present invention, a control unit for activating at least one safety device may also be provided, which includes the following features:
at least one interface which is designed to form a feature vector from at least two features from at least one signal of a crash sensor system;
an evaluation circuit which is designed to classify the formed feature vector into one of at least three possible feature classes with the aid of a classifier based on the statistical learning theory; and
an activation unit which is designed to activate the safety device in accordance with an activation instruction for the feature class in which the feature vector was classified.

The object of the present invention may be achieved quickly and efficiently by this embodiment variant of the invention in the form of a device, as well. In particular, the combination of the use of a classifier based on the statistical learning theory, with the possibility of classifying the feature vector in one of at least three feature classes permits an evaluation of the sensor signals available that is more precise, faster and therefore improved compared to the related art.

In a further specific embodiment of the present invention, a computer program is provided that executes all steps of the method according to one of the specific embodiments described above when it runs on a control unit. This computer program may be written originally in a high-level programming language, and is then translated into a machine-readable code.

Also advantageous is a computer-program product having program code which is stored in a machine-readable medium such as a semiconductor memory, a hard-disk storage or an optical memory, and is used to implement the method according to one of the specific embodiments described above when the program is executed in a control unit.

### BRIEF DESCRIPTION OF THE DRAWINGS

In the following, the present invention is explained in greater detail by way of example, with reference to the figures.

FIG. 1 shows a block diagram of a first exemplary embodiment of the present invention as a unit installed in a vehicle.

FIG. 2 shows a block diagram of a second exemplary embodiment of the present invention.

FIG. 3 shows a block diagram of a third exemplary embodiment of the present invention.

FIG. 4 shows a block diagram of a fourth exemplary embodiment of the present invention.

FIG. 5 shows a flow chart of a fifth exemplary embodiment of the present invention.

### DETAILED DESCRIPTION OF EXAMPLE EMBODIMENTS

Identical or similar elements may be provided with identical or similar reference characters in the following figures. Furthermore, the figures and their descriptions contain numerous features in combination. In this context, these features may also be considered individually or may be combined to form further combinations not explicitly described here.

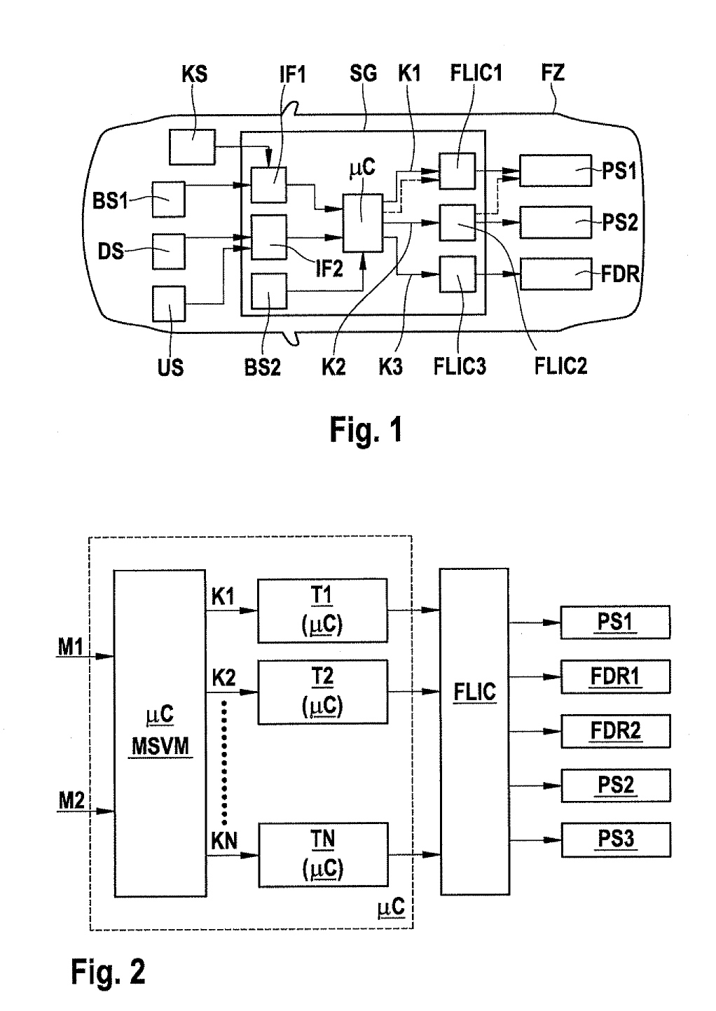

FIG. 1 shows a block diagram of a first exemplary embodiment of the present invention. Control unit SG of the present invention, together with connected components, is explained in greater detail with the aid of this block diagram. Control unit SG, which is connected to various components, is disposed in a vehicle FZ. Only the components outside of and within the control unit which are necessary to understand the present invention are shown by way of example in this case.

Various crash sensors such as a structure-borne-noise sensor system KS, an acceleration sensor system BS1, a pressure sensor system DS and a driving-environment sensor system US are connected to control unit SG. Further sensors such as a vehicle-dynamics sensor system and/or yaw-rate sensors, etc., may be connected in addition to or instead of the sensors described above. Various mounting positions in vehicle FZ for this purpose are possible. Structure-borne-noise sensor system KS and acceleration sensor system BS1 are connected to a first interface IF1 of control unit SG, interface IF1 supplying the signals to evaluation circuit μC which, according to the first exemplary embodiment, is in the form of microcontroller μC. Alternatively, evaluation circuit μC may be a different element having a data-processing functionality such as a general microprocessor, a digital signal processor DSP, an application-specific integrated circuit ASIC or a programmable logic module FPGA (FPGA=field programmable gate array=logic module programmable on-site). A second interface IF2, to which an air-pressure sensor system DS and driving-environment sensor system US are connected, for example, makes these signals available to evaluation circuit μC. Air-pressure sensor system DS may also be installed in the side sections of the vehicle, and is then intended to be used as a side-impact sensing system. Driving-environment sensor system US may include various driving-environment sensors such as radar, LIDAR, video or ultrasound in order to analyze the driving environment of vehicle FZ, with respect to collision objects. Microcontroller μC receives further sensor signals from an acceleration sensor system BS2 within control unit SG via an internal interface of the control unit. Additional sensors may be located within control unit SG and may output signals to microcontroller μC via corresponding interfaces. Among these are vehicle-dynamics sensors and/or structure-borne-noise sensors.

The interfaces receive the signals from the crash sensor system, extract certain features from this crash sensor signal such as an acceleration, an integral thereof, a rotational speed, etc., and combine a certain number of these features to form a feature vector. For example, the signal may be an acceleration signal, and one of the interfaces may determine the velocity from it by simple integration and then, from the acceleration and the velocity, form a two-dimensional feature vector which is made available to the evaluation circuit, especially to the classifier.

Located in microcontroller μC is a classifier based on the statistical learning theory, which is explained in greater detail below. The feature vector is supplied to this classifier, the classifier also being able to process a multi-dimensional feature vector, depending upon how many features are intended to go into the classification. The classifier categorizes the feature vector into one of at least three feature classes K1, K2 or K3. For instance, these feature classes characterize different crash types or crash severities, so that for each crash type or for each crash severity, correspondingly suitable safety device may be activated. For example, a first personal-protection device PS1 in the form of an airbag may be activated by first activation circuit FLIC1 if the classifier in microcontroller μC has classified the feature vector into feature class K1. Analogously, a second personal-protection device PS2 (e.g., a seat-belt pretensioner) may be activated by a second activation circuit FLIC2 if the classifier in microcontroller μC has categorized the feature vector into second feature class K2. In the event the classifier in microcontroller μC has categorized the feature vector into third feature class K3, a vehicle-dynamics control FDR (like, for example, an ESP (electronic stability program) control) may be activated via a third activation circuit FLIC3. This transmission may be especially protected if it takes place via the SPI bus (SPI serial peripheral interface). The suitable activation circuits may be enabled very easily in that, for example, due to the classification in one (feature) class K1, K2 or K3, only one (binary) on/off activation of the corresponding activation circuit takes place, which is evaluable in quick and uncomplicated fashion.

In the present case, control unit SG has a housing which may be made of metal and/or plastic. Microcontroller pC itself has an internal memory, but is also able to access external memories which are likewise located in control unit SG. Class boundaries may also be stored in the memory, which, for example, were determined during pretraining of the classifier in the laboratory as described in greater detail below. Using these class boundaries, the classifier in microcontroller μC is able to categorize the feature vector very quickly and in easily realizable manner into the different feature classes K1, K2 or K3.

It is possible that more or fewer than the sensors shown are used. For example, the communication of interfaces IF1 and IF2 to microcontroller μC may take place via internal bus SPI of the control unit. The SPI bus may also be used for the communication between microcontroller μC and activation circuits FLIC1, FLIC2 and FLIC3. In the present case, activation circuits FLIC1, FLIC2 and FLIC3 are made up of one or more integrated circuits which have power circuit breakers, for example, and when in activation operation, permit current to be supplied to the trigger elements or activation elements of personal-protection devices PS1 or PS2 or of vehicle-dynamics controller FDR. These personal-protection devices PS1 or PS2 or vehicle-dynamics controller FDR may also have various forms which are made up of one or more integrated circuits and/or discrete components.

Classifiers based on the statistical learning theory, which subdivide a feature vector into one of at least three feature classes, are considered specifically for use in the present invention. In this manner, with the aid of an automated method, one succeeds in evaluating the plurality of signals and signal combinations to be taken into account. Owing to the automatic evaluation, the signal combinations should no longer result—on account of the limitedly manageable scope of data—exclusively from driving tests actually run (like, for example, the standardized indoor crash test Euro NCAP (New Car Assessment Program)), but rather, to an increasing extent, results from vehicle-dynamics simulations and FEM simulations (FEM=finite element model) may be processed, as well. If no automatic evaluation were used, the number of signal combinations to be taken into account could not be handled. Thus, by the imaging of a real-world-safety-development process, advantageously, any simulated crash situations desired may be evaluated automatically, thereby permitting even better training of the classifier.

It should also be noted that, due to the classification of the feature vector in one of more than two feature classes, the features of crash signals are evaluated in greater detail than is conventionally possible. Particularly owing to the automated evaluation of the history of a vehicle movement in a very early crash phase, on the basis of the finely graded classification of the features of a crash signal into many feature classes, for instance, different branches of the further algorithm processing may be enabled by the activating based on feature classes. Due to the advantageous early classification of the features of a crash signal and the correspondingly rapid activation of the most suitable safety device, the reaction time of the safety device is thereby reduced on one hand, and on the other hand, only those safety devices are activated which are actually affected by the instantaneous driving situation. Resources are thereby saved.

Furthermore, owing to the possibility of combining features from a multitude of available crash signals, an imaging of or reaction to driving situations may also be realized which were caused by active and passive safety components. In addition, the classifier may easily be adapted to danger situations and crash situations requested by customers by the use of simulation data. Moreover, the use of methods based on machine learning reduces the application time considerably, so that training runs with extensive signal combinations for training the classifier in a laboratory are feasible in realistic time, as well. Therefore, the classifier proposed is able to be trained substantially better compared to conventional classifiers, which proves to be advantageous upon its use in a more precise selection of the correct feature class for a predefined feature vector.

In example embodiments of the present invention, a multiclass support vector machine (MSVM) may be used specifically as classifier based on the statistical learning theory, since such a multiclass support vector machine, as well as a support vector machine, supplies an optimal solution, and exhibits a low tendency to specialization (i.e., to memorization of the trained data).

An exact functioning method of a support vector machine (SVM) as basis of the multiclass support vector machine is described, for example, in German Patent Application No. DE 102007 027649. Further information regarding SVMs is also in literature, e.g., Cristianini, Nello and Shawe-Taylor, John: “An Introduction to Support Vector Machines and Other Kernel-Based Learning Methods” or Hastie: “The Elements of Statistical Learning.” To avoid redundancies, a detailed description of the functioning method of SVMs shall be dispensed with at this point.

In contrast to conventional support vector machines which distinguish between two classes (e.g., in the case of crash discrimination, between a feature class “Fire” for activating a safety device and a feature class “No Fire” for the non-activation of the corresponding safety means, or between the feature classes “ODB”/“NonODB” (ODB=offset deformable barrier), the multiclass support vector machine (MSVM) is able to differentiate a plurality of classes, especially more than 3 classes. The MSVM is likewise a machine-learning-based method of the class of the statistical learning theory, in which the classifier is trained by the pair-wise stipulation of feature vectors and associated class. The training of such a MSVM is discussed in greater detail below.

The specific usage of a classifier based on the statistical learning theory is shown in FIG. 2 as a block diagram of a second exemplary embodiment of the present invention. In this case, the classifier, which is disposed in microcontroller μC, for example, is able to receive features M1 and M2 of crash signals (e.g., with respect to a wheel speed, a yaw acceleration, an integral of the longitudinal acceleration or an overlapping ratio of a precrash sensor) and is trained in such a way that the individual feature classes K1 through KN represent different vehicle states (such as “skidding”, “front crash”, “mild side crash-soft crash”, . . . ). Different activation circuits or algorithm parts or activation instructions for activating safety device may be enabled accordingly. For example, given the classification of the feature vector made up of features M1 and M2 into feature class K1, a first sub-algorithm T1 may be enabled as triggering algorithm in microcontroller μC, which, via an activation circuit FLIC for a front airbag, then activates personal-protection device PS1 in the form of firing pellets, reversible restraints or the like. A separate trigger circuit would also be possible, in which the functionalities of first sub-algorithm T1 and activation circuit FLIC are implemented, which is enabled by the classification of features M1 and M2 into class K1, and which on its part, activates personal-protection device PS1.

Analogously, in the case of a classification of the feature vector into feature class K2, a second sub-algorithm T2 in microcontroller μC may be activated, which on its part, enables activation circuit FLIC for the execution of a soft-crash functionality that, on its part, then activates a vehicle-dynamics controller FDR1 in the form of a braking requirement. A separate component for realizing second sub-algorithm T2 and the functionality of the FLIC may potentially be used here again, as well.

Correspondingly, given the classification of the feature vector into a third feature class, a third sub-algorithm, not shown explicitly in FIG. 2, is able to be activated, which via activation circuit FLIC, here in the form of a regulating unit, then activates a second vehicle-dynamics controller FDR2 for the wheel-selective braking or steering in order to improve the vehicle dynamics.

If the classifier categorizes the feature vector into a fourth feature class, a fourth sub-algorithm, likewise not shown in FIG. 2, is able to be activated. This fourth sub-algorithm, by way of activation circuit FLIC, is then able to initiate a triggering of second personal-protection device PS2, e.g., a side airbag, so that second personal-protection device PS2 activates firing pellets or reversible restraints accordingly.

If, for example, the feature vector is classified in a further feature class KN, an EPP algorithm (EPP=Electronic Pedestrian Protection=Pedestrian. Protection Algorithm) may be activated as the corresponding nth sub-algorithm TN, by which a further personal-protection device PS3 in the form of firing pellets or reversible restraints is activated via activation circuit FLIC.

Unlike the representation in FIG. 2, it is also possible to in each case provide separate activation circuits FLIC1, FLIC2, . . . for individual personal-protection devices PS1, PS2 and PS3, respectively, or for individual vehicle-dynamics controllers FDR1 and FDR2, respectively, as was already broached briefly above and is described in greater detail with reference to FIG. 4.

The representation from FIG. 2 may also be continued for a classification of the feature vector into any number (but more than three) feature classes, suitable safety devices then being activated via the enablement of a correspondingly matched sub-algorithm and activation circuit FLIC. By the design of the classifier for classification of the feature vector into at least three feature classes, it thus becomes possible, based on the features of one or more crash signals, to activate exactly those parts of a vehicle safety system which are needed precisely in the driving situation occurring. Complicated processing of all available algorithm parts of the safety system or constant enablement of all activation circuits may therefore be omitted.

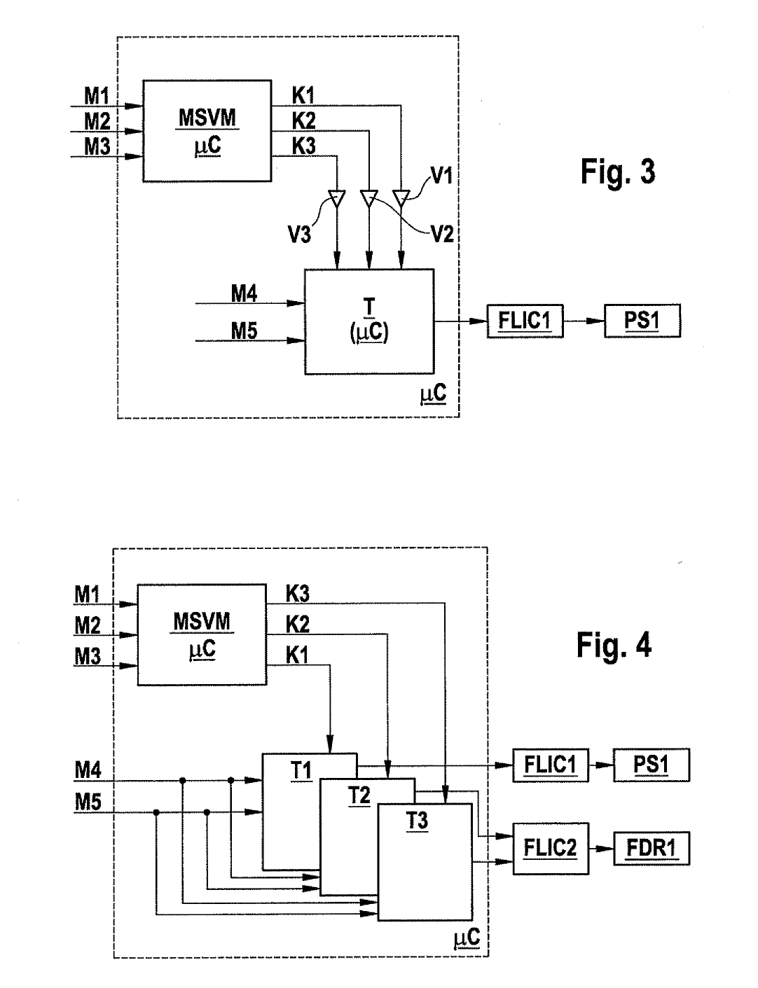

FIG. 3 shows a third exemplary embodiment of the present invention as a block diagram, a single sub-algorithm T of sub-algorithms T1 through TN depicted in FIG. 2 being shown specifically for the purpose of illustrating the mode of action of the present invention. However, the present invention may also be employed using only a single sub-algorithm T, so that a plurality of sub-algorithms is not needed. In the exemplary embodiment shown in FIG. 3, a multiclass support vector machine MSVM is used as classifier in microcontroller μC, to which features M1, M2 and M3 are applied. For instance, these features may be generated from one crash signal, as was described above for FIG. 2 with reference to the wheel-speed signals, the yaw acceleration, the vehicle acceleration, etc., or their integrals. Classifier MSVM is able to categorize features M1, M2 and M3 into a first, second or third feature class K1, K2 or K3, and feeds them to sub-algorithm T which enables an activation circuit FLIC1. Thus, in combination with activation circuit FLIC1 and sub-algorithm T, an activation instruction is realized numerically and/or in terms of circuit engineering by which, in response to crash-signal features M4 and M5, personal-protection device PS1, e.g., an airbag, is activated. Sub-algorithm T may be designed in such a way that it implements a physically-based kernel threshold decision whose decision threshold value is influenced by feature classes K1, K2 or K3. In this context, personal-protection device PS1 is triggered or activated in response to crash-signal features M4 and M5, which, however, may be identical to one or more of input features M1 through M3 or derived from them.

The influencing of the decision threshold value may involve an under-allowance or over-allowance in accordance with a modification instruction for feature class K1 through K3 selected in each case. This ensures that, even in the event of a possibly faulty classification, personal-protection device PS1 is (even though not optimally, but nevertheless) always activated by sub-algorithm T with the physically-based kernel threshold decision implemented therein.

As described above, since multiclass support vector machines implement a learning-based method, after the training, the classification may be carried out on the basis of a mathematical relation like, for example, the following equation

$$f ( x ) = {\sum }_{l = 1}^{1} {y}_{i} \cdot {α}_{i} \cdot k ( {x}_{i} ; x ) + b .$$

In this instance, variables yᵢ aᵢ and b are results of the training and k(xᵢ, x) the utilized trained kernel function of the multiclass support vector machine. The result of this classification function corresponds to the class determined in the classifier, for example, a real, that is, non-binary classification functional value of 3.1 corresponding to feature class K3 which includes all classification functional values between 3.0 and 3.9. Sub-algorithm T in FIG. 3 may then be realized by a (binary) on/off activation of the signal path for feature class K3. Alternatively, the precisely ascertained classification functional value of 3.1 may also be transmitted to sub-algorithm T for the activation, which means, for example, a quantitatively more exact increase or reduction of the decision threshold value may be implemented in the activation instruction of the sub-algorithm. The equivalent holds true for the transmission of classification functional values for feature classes K1 and K2, as well, in doing which, if necessary, an amplification of the respective classification functional values by amplifiers V1 through V3 also being possible in order to compensate for or to mask interferences on the signal lines to the greatest extent possible.

FIG. 4 shows a fourth exemplary embodiment of the present invention in a block diagram. According to the exemplary embodiment shown in FIG. 4, a classifier in the form of a multiclass support vector machine MSVM is again provided in a microcontroller tiC, to which features M1 through M3 of one or more crash signals are supplied. Features M1 through M3 are combined in classifier MSVM (or via a series-connected integrated interface) to form a feature vector M, and it is classified in one of feature classes K1 through K3. Each of these feature classes K1 through K3 is used to drive a sub-algorithm T1 through T3, which in each instance are again acted upon by features M4 and M5 of a crash signal. Corresponding to the explanations with respect to the exemplary embodiment depicted above in FIG. 3, features M4 and/or M5 may again be identical to one or more of input features M1 through M3 of classifier MSVM or derived from them.

In each case, an activation instruction in the form of a physical kernel threshold decision may be implemented in sub-algorithms T1 through T3, the classification of the feature vector into one of feature classes K1 through K3 making it possible to switch between various kernel thresholds in the different sub-algorithms T1 through T3. For example, a first decision threshold value may be implemented in first sub-algorithm T1, first sub-algorithm T1 being enabled by the classification of the feature vector in feature class K1. Upon enablement of first sub-algorithm T1, a personal-protection device PS1 such as an airbag, for example, is able to be activated via first activation circuit FLIC1.

Furthermore, a second decision threshold value differing from the first decision threshold value may be implemented in second sub-algorithm T2, second sub-algorithm T2 being activated by the classification of the feature vector into feature class K2. The second sub-algorithm likewise again uses features M4 and M5 to trigger a safety device, and likewise again implements a physically-based kernel threshold decision. If the feature vector is classified into third feature class K3, third sub-algorithm T3 may be activated, which implements a third physically-based kernel threshold decision with a further decision threshold value, using features M4 and M5. In this context, the decision threshold value in second and third sub-algorithms T2 and T3, respectively, may again be altered by the evaluation of a transmitted classification functional value for second and third feature classes K2 and K3, respectively.

Second sub-algorithm T2 and third sub-algorithm T3 are able, by way of a common second activation circuit FLIC2, to enable a vehicle-dynamics control FDR1, e.g., an activation of an ESP function. In this case, for example, it is possible to determine the plausibility of the activation of first personal-protection device PS1 by comparing the two control signals of second and third sub-algorithms T2 and T3 for this protection device PS1 in accordance with a predefined setpoint selection. For instance, if the second decision threshold value is lower than the third decision threshold value, an error must exist if second sub-algorithm T2 signals that a value from the considered features of the crash signal lies below the second decision threshold value, but third sub-algorithm T3 signals that the value from the considered features of the crash signal lies above the third decision threshold value.

First and second activation circuits FLIC1 and FLIC2 may also be implemented together in one activation circuit, as shown accordingly in FIG. 2. The individual sub-algorithms may likewise be implemented together in microcontroller μC or in separate signal-processing modules. Furthermore, given the classification of the feature vector in first feature class K1, the first decision threshold value may be loaded from a look-up table, for example, or a memory into the first sub-algorithm. Analogously, if the feature vector is classified in second feature class K2, the second decision threshold value may be loaded from a look-up table or a memory into the second sub-algorithm, and if the feature vector is classified in third feature class K3, the third decision threshold value may be loaded from the look-up table or a memory into the third sub-algorithm. Depending upon the severity of the crash occurring, which is characterized by the classification of the feature vector into a corresponding feature class, vehicle-dynamics control FDR1, e.g., an automatic brake controller, may be activated with variable strength (for example, in different steps) via the activation of second and third sub-algorithms T2 and T3, respectively, as shown in FIG. 4.

Thus, it becomes apparent that the description above discloses various forms of the present invention which may also be combined in different ways in order to realize the advantages of the invention in the best way possible. For example, a combination of the exemplary embodiments from FIGS. 2 and 4 may be implemented. Such a design is represented in FIG. 1 by the two dashed lines where, corresponding to the exemplary embodiment from FIG. 4, microcontroller μC delivers a plurality of control signals, which are obtained from different sub-algorithms, to a single activation circuit (dashed line between microcontroller μC and first activation circuit FLIC1), or, corresponding to FIG. 2, one activation circuit activates a plurality of protection devices (dashed line between second activation circuit FLIC2 and first personal-protection device PS1). Applying a plurality of classification signals to a single sub-algorithm according to the exemplary embodiment from FIG. 3 is not illustrated explicitly in FIG. 1; however, based on the above description, this further combination of the above-described exemplary embodiments is easy to implement as well.

Especially in the case of the exemplary embodiments of the present invention illustrated in FIGS. 3 and 4, no longer is just one binary classification decision output, but rather, differentiation is made between a plurality of feature classes. This is advantageous, since when classifying a crash, it is desirable to be able to distinguish between different crash types, and it is often not precise enough to obtain merely a binary “fire”/“no fire”-decision for triggering the corresponding personal-protection device at the output of a classifier or an activation circuit. The severity of the crash may be determined better on the basis of the crash type classified in greater detail, and therefore the activation, e.g., of the corresponding firing devices, may be improved. The components of a vehicle safety system needed in the instantaneous driving situation may be switched in selectively as a function of the classification result in order, for example, to precisely modify a kernel threshold in an activation unit in such a way that the triggering requirements are satisfied for the classified crash type. This corresponds generally to the exemplary embodiment shown in FIG. 3. However, it is also possible to load different look-up tables for the corresponding kernel threshold on the basis of the classification result, thus, to de facto switch back and forth between kernel thresholds matched to the respective crash types. This is generally realized in the exemplary embodiment shown in FIG. 4.

It is further possible to switch in special functions on the basis of the classification result. For example, if a full frontal crash (i.e., a crash without overlap against a non-deformable barrier) is classified, then what is termed the low-risk function may be started in order, if applicable, to induce the suppression of a second airbag stage. For this purpose, it may thus be necessary, for instance, to distinguish between crash classes (i.e., feature classes) K1=“ODB”, K2=“AZT'” and K3=“Full Frontal”, the class “AZT” being intended to identify a “non-triggering crash test against a fixed barrier.”

Based on a plurality of crash-signal feature combinations, it is possible in the manner proposed above to ensure extremely quickly and in very easy fashion numerically or in terms of circuit engineering, the best reaction of a vehicle safety system to an instantaneous driving situation. As may be gathered from the equation cited above, it is not complicated to calculate numerically, and thus does not represent any great challenge for modern data-processing components, which constitutes a great advantage for the implementation.

However, an important aspect is the training of the classifier used in the proposed invention. In contrast to the conventional support vector machine (SVM), which differentiates only between two classes (and, for example, between “Fire” and “No Fire” in the case of the crash discrimination), the multiclass support vector machine (MSVM) is able to differentiate a plurality, especially more than two feature classes. The multiclass support vector machine is likewise a learning-based method, the classifier being trained by the pair-wise stipulation of input-feature vectors having the features of crash signals to be trained and output signals in the form of the feature class to be assigned in each instance. In the training, the classifier calculates the support vectors which contain the most important data points of the respective class. The support vectors may be understood as the support vectors of a separation line or separation plane which separates the individual classes from each other. What is remarkable in respect to the multiclass support vector machine as well as the support vector machine is that, by calculating the support vectors, exactly that separation line is determined which has the maximum distance to the various classes. This is particularly advantageous, since it means the most robust separation of the classes in the event of sensor-signal fluctuations. A further advantage is the fact that this optimal separation line is always found, which is not so in the case of other methods based on machine learning, such as neural networks. The training takes place in a laboratory, the support vectors found being stored, for example, in a memory (such as an EEPROM of an airbag control unit in the form of a microprocessor). In this context, the above-named variables of the equation cited may be ascertained in the training, so that during the running time of the algorithm prior to or during the crash, the classifier is able to classify the feature vector with the aid of the (trained) simple equation described above.

It should be noted as a special feature of the training of a multiclass support vector machine that in the final analysis, the training of such a machine is always reduced to the two-class case, so that differentiation is made between two different training variants. A first training variant (“one versus one”) is based on the fact that in each case, two classes are trained versus each other in succession. Thus, in the case of 3 classes, first of all, class 1 is trained versus class 2, after that, class 2 is trained versus class 3, and after that, class 3 is trained versus class 1. The classification results obtained are subsequently combined. A second training variant (“one versus rest”) is based on the fact that one after another, one class is always trained versus all remaining classes. Thus, in the case of three classes, class 1 is trained versus classes 2 and 3, after that, class 2 is trained versus classes 1 and 3, and after that, class 3 is trained versus classes 1 and 2. The classification results obtained are subsequently combined, as well. Depending upon the problem faced, one time the first training variant, and another time the second training variant may be used. In this manner, due to the automated calculation of the separation plane, the application time of additional functions for triggering a safety device may be reduced considerably.

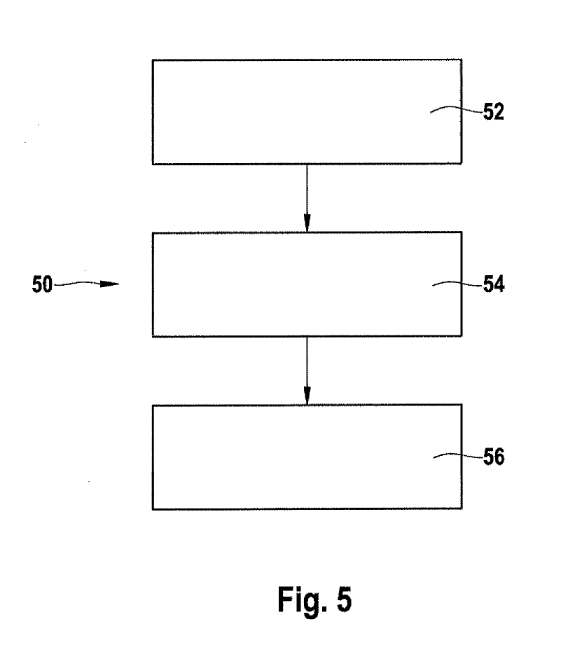

FIG. 5 shows a fifth exemplary embodiment of the present invention. In this case, the present invention takes the form of method 50 for activating at least one safety device according to the procedure described above upon operation of such a classifier based on the statistical learning theory. Method 50 has a first step 52 of acquiring at least two features M1, M2 from at least one signal of a crash sensor system in order to form a feature vector from the acquired features. In a second step 54, the feature vector formed is classified with the aid of a classifier based on the statistical learning theory in order to classify the feature vector into one of at least three possible feature classes K1, K2, K3. In a third method step 56, safety devices FOR, PS1, PS2 are activated in accordance with an activation instruction for the feature class K1, K2, K3 in which the feature vector was classified. An object of the present invention may be achieved by this method 50, as well, the advantageous effects described being obtained.

The example method according to the present invention may be implemented in hardware or in software, depending on the circumstances. The implementation may be realized on a digital storage medium, particularly a diskette, a CD or a DVD with control signals able to be read out electronically, which are able to cooperate with a programmable computer system in such a way that the corresponding method is executed. In general, the present invention is thus also made up of a computer-program product having program code, stored on a machine-readable medium, for implementing the method of the present invention when the computer-program product runs on a computer. In other words, the present invention may thus be realized as a computer program having a program code for implementing the example method when the computer program is executed on a computer.

1-12. (canceled)

13. A method for activating at least one safety device, comprising:
acquiring at least two features from at least one signal of a crash sensor system to form a feature vector from the acquired features;
classifying the formed feature vector using a classifier based on a statistical learning theory to classify the feature vector in one of at least three possible feature classes; and
activating the safety device in accordance with an activation instruction for the feature class in which the feature vector was classified.

14. The method as recited in claim 13, wherein the classifying includes using a multiclass support vector machine.

15. The method as recited in claim 13, wherein the activating of the safety device in accordance with an activation instruction for a first feature class includes activating a personal-protection device and an activating of the safety device in accordance with an activation instruction for a second feature class includes activating a vehicle-dynamics support control.

16. The method as recited in claim 13, wherein the activating of the safety device is further accomplished using one of at least one feature of the feature vector or a further feature from a signal of the crash sensor system.

17. The method as recited in claim 13, wherein upon classifying, a classification functional value is ascertained, and the activating of the safety device is accomplished using the classification functional value.

18. The method as recited in claim 13, wherein the activating of the safety device is accomplished in accordance with an activation instruction that is based on a decision threshold value.

19. The method as recited in claim 13, wherein in the activating step, the activation instruction is modified in accordance with a modification instruction as a function of the feature class.

20. The method as recited in claim 18, wherein in the activating as a function of the feature class, the decision threshold value is one of: i) increased, ii) decreased, or iii) the decision threshold value is replaced, by a second decision threshold value.

21. The method as recited in claim 13, wherein the classifying is carried out based on class boundaries between the feature classes, which are loaded from a memory.

22. A control unit for activating at least one safety device, comprising:
at least one interface adapted to form a feature vector from at least two features from at least one signal of a crash sensor system;
an evaluation circuit adapted to classify the formed feature vector into one of at least three possible feature classes using a classifier based on a statistical learning theory; and
an activation unit adapted to activate the safety device in accordance with an activation instruction for a feature class in which the feature vector was classified.

23. A storage medium storing computer program that executes in a control unit, the computer program, when executed by the control unit, causing the control unit to perform the steps of:
acquiring at least two features from at least one signal of a crash sensor system to form a feature vector from the acquired features;
classifying the formed feature vector using a classifier based on a statistical learning theory to classify the feature vector in one of at least three possible feature classes; and
activating a safety device in accordance with an activation instruction for the feature class in which the feature vector was classified.

24. A computer-program product having program code, stored on a machine-readable medium, the program code, when executed in a control unit, causing the control unit to perform the steps of:
acquiring at least two features from at least one signal of a crash sensor system to form a feature vector from the acquired features;
classifying the formed feature vector using a classifier based on a statistical learning theory to classify the feature vector in one of at least three possible feature classes; and
activating a safety device in accordance with an activation instruction for the feature class in which the feature vector was classified.
